(19) United States
(12) Patent Application Publication
(10) Pub. No.: US 2021/0172202 A1
(43) Pub. Date: Jun. 10, 2021

(54) ELECTRONIC LOCKING APPARATUS

(71) Applicant: Brandon Linz, Monrovia, CA (US)

(72) Inventor: Brandon Linz, Monrovia, CA (US)

(21) Appl. No.: 17/111,740

(22) Filed: Dec. 4, 2020

Related U.S. Application Data
(60) Provisional application No. 62/943,564, filed on Dec. 4, 2019.

(51) Int. Cl. E05B 45/00; E05B 17/10

(52) U.S. Cl. CPC E05B 45/005; E05B 2047/0094; E05B 17/10

(57) ABSTRACT

An electronic locking apparatus is disclosed, including a housing having a locking mechanism to accept a key. A cable is attached to the left side of the housing and extends to a first end including a locking base. The locking base releasably engages with a receiver positioned on the housing. The locking mechanism selectively engages and releases the locking base from the receiver. The cable is dimensioned to secure a toolbox to permit unauthorized entry thereto. An alarm system includes at least one audio element and at least one visual element and is in electrical communication with the cable to determine if the cable is tampered with. An interface is in operable communication with the alarm system to permit the user to select alarm instructions of the alarm system.

### CROSS-REFERENCE TO RELATED APPLICATIONS

The present application claims priority to U.S. Provisional Patent Application 62/943,564 filed on Dec. 4, 2019, entitled “TOOL ALARM LOCKING APPARATUS,” the entire disclosure of which is incorporated by reference herein.

### TECHNICAL FIELD

The embodiments relate to locks and, more specifically, to electronic locks to secure tools.

### BACKGROUND

Locking devices are commonly used to protect property, such as real estate, bicycles, and other personal items. Historically, mechanical locks utilize a mechanical fastening device that is released by a physical object (such as a key, keycard, fingerprint, RFID card, or similar device), or by supplying information (such as a number or letter combination or a password).

Tools are a common target of theft from both jobsites and homes. Existing locking devices include lockboxes and tool locks, which rely on traditional locking mechanisms. Such existing devices may be tampered with by lockpicks, cutters, angle grinders, and other tools.

While many locks are constructed of resilient materials, such as hardened metals, to increase the integrity of the device and prevent the ability to forcibly open the lock, given the proper tools, skilled thieves are often still able to remove the lock from whatever item it is securing.

### SUMMARY OF THE INVENTION

This summary is provided to introduce a variety of concepts in a simplified form that is further disclosed in the detailed description. This summary is not intended to identify key or essential inventive concepts of the claimed subject matter, nor is it intended for determining the scope of the claimed subject matter.

The embodiments provided herein disclose an electronic locking apparatus, including a housing having a locking mechanism to accept a key. A cable is attached to the left side of the housing and extends to a first end, including a locking base. The locking base releasably engages with a receiver positioned on the housing. The locking mechanism selectively engages and releases the locking base from the receiver. The cable is dimensioned to secure a toolbox to permit unauthorized entry thereto. An alarm system includes at least one audio element and at least one visual element and is in electrical communication with the cable to determine if the cable is tampered with. An interface is in operable communication with the alarm system to permit the user to select alarm instructions of the alarm system. The electronic locking apparatus may be readily deployed on various toolbox configurations to secure the toolbox when in a locked configuration.

In one aspect, the alarm system comprises a memory configured to store alarm instructions.

In one aspect, the alarm instructions instruct the audio element to produce sound through at least one speaker positioned on the housing.

In one aspect, the alarm instructions instruct the visual element to emit light via an LED positioned on the housing.

In one aspect, the alarm system further comprises a transceiver to emit an alert signal to a remote device.

In one aspect, the locking base is configured as an elongated member capable of at least partially extending through an aperture at a center of the receiver.

In one aspect, the housing includes a pivotable door to permit access to an interior of the housing.

In one aspect, the locking mechanism includes one of a keyed cylinder, a combination cam, and an electronic cam including a fingerprint scanner.

### BRIEF DESCRIPTION OF THE DRAWINGS

A more complete understanding of the present invention and the advantages and features thereof will be more readily understood by reference to the following detailed description when considered in conjunction with the accompanying drawings wherein:

FIG. 1 illustrates a perspective view of the tool alarm locking apparatus securing a toolbox, according to some embodiments;

FIG. 2 illustrates a perspective view of the housing and internal components of the electronic locking apparatus, according to some embodiments;

FIG. 3 illustrates a perspective view of the electronic locking apparatus and locking mechanism, according to some embodiments;

FIG. 4 illustrates a perspective view of the housing of the electronic locking apparatus, according to some embodiments;

FIG. 5 illustrates a cutaway view of the power switch and power source of the electronic locking apparatus;

FIG. 6 illustrates a perspective view of the electronic locking apparatus, according to some embodiments; and

FIG. 7 illustrates a block diagram of the alarm system, according to some embodiments.

### DETAILED DESCRIPTION

The specific details of the single embodiment or variety of embodiments described herein are to a system and method of use. Any specific details of the embodiments are used for demonstration purposes only and no unnecessary limitations or inferences are to be understood therefrom.

Before describing in detail exemplary embodiments, it is noted that the embodiments reside primarily in combinations of components related to the system and method. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second”, “top” and bottom”, and the like, may be used solely to distinguish one entity or element from another entity or element without necessarily requiring or implying any physical or logical relationship or order between such entities or elements.

In general, the embodiments provided herein relate to an electronic locking apparatus for a toolbox or other selectively openable container. The electronic locking apparatus includes an alarm, which is activated when the electronic locking apparatus and/or the toolbox is tampered with. The electronic locking apparatus may be readily deployed on various toolbox configurations to secure the toolbox when in a locked configuration.

FIG. 1 illustrates a perspective view of the electronic locking apparatus 100 configured to secure and lock a toolbox 103 via cable 104 extending around the toolbox to prevent the toolbox 103 from being opened and/or tampered with. The illustrated example in FIG. 1 shows the electronic locking apparatus 100 in a locked configuration wherein the cable 104 extends around the toolbox 103 and prevents the doors 106, 108 from being opened. Once in the locked configuration, the electronic locking apparatus 100 is armed and capable of emitting audible and visual alarms, as well as transmitting alerts to a remote device.

The alarmed locking apparatus 100 may be configured to secure various toolbox 103 configurations, including tool cabinets, tool sheds, toolboxes (portable or stationary), or other containers wherein tools are stored. The alarmed locking apparatus 100 may be especially useful for situations wherein tools are left unattended for long periods of time, making them vulnerable to theft or tampering.

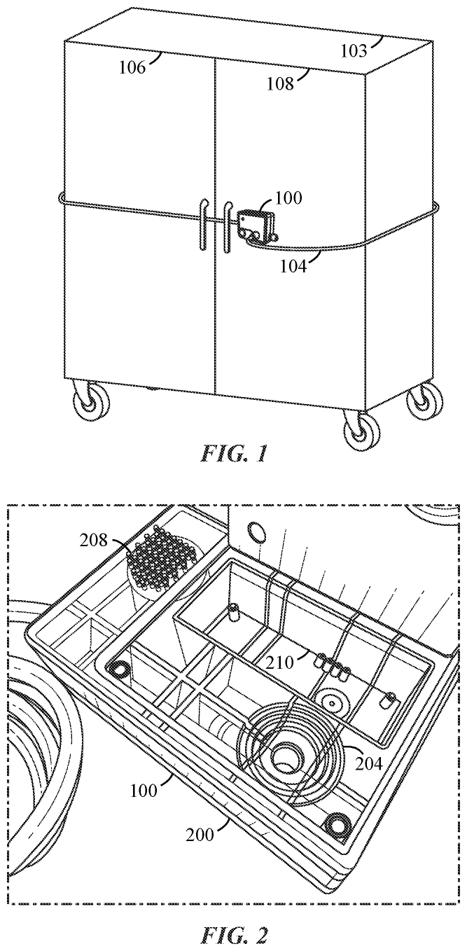

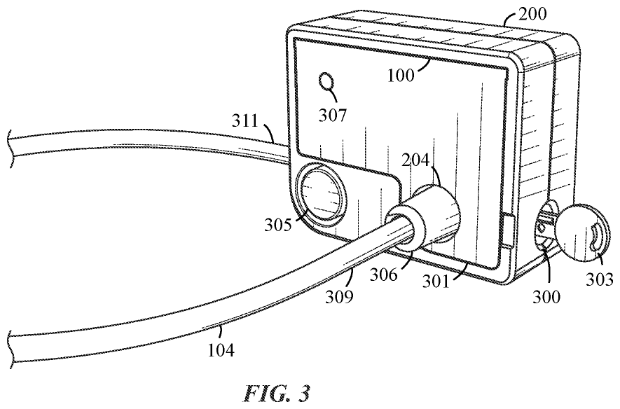

FIG. 2 illustrates a perspective view of the housing 200 and internal components of the electronic locking apparatus 100. The housing 200 comprises a locking mechanism having a receiver 204 to releasably engage with the locking base 306 (see FIG. 3). A speaker 208 is operable to produce a sound upon reception of an alarm signal to act as a theft deterrent. The housing 200 provides protection from debris, moisture, shock, and tampering of the internal components of the electronic locking apparatus 100. A cavity 210 is provided within the housing 200 for the electrical components to be disposed therein, including a PCB, microprocessor, transceiver, power source (e.g., batteries), and necessary wiring.

In some embodiments, the power source may include lithium batteries, rechargeable batteries, solar cells, or other power sources known in the arts. Further, the electronic locking apparatus 100 may include an external power source.

FIG. 3 illustrates a perspective view of the electronic locking apparatus 100 and locking mechanism 300. The locking mechanism 300 is at least partially disposed through a sidewall 301 of the housing 200 and is configured to accept a key 303 to lock and unlock the locking mechanism 300 during use. In the illustrated example, the electronic locking apparatus 100 is illustrated in a locked configuration with the locking base 306 engaged with the receiver 204. An interface 305 is provided to allow the user to activate and deactivate the alarm system. The interface may include one or more buttons, one or more displays (e.g., touch screen displays, interactive displays, and the like), one or more indicators 307 (e.g., LED lights), and the like. Indicator 307 is illustrated in an exemplary embodiment to show how an indicator, such as an LED light, may be positioned on any surface of the housing 200. The locking base 306 is disposed at a first end 309 of the cable 104 to connect and disconnect from the receiver 204 when the key 303 is turned. In such, the locking mechanism 300 is in communication with the receiver 204 to retain the locking base 306 therein when the key 303 is turned to the locked position. A second end 311 of the cable 104 is attached to the housing 200 to provide a closed loop once the locking base 306 at the first end 309 is engaged with the receiver 204.

In some embodiments, the interface 305 allows the user to select from a plurality of preprogrammed operational settings stored in a memory. For example, the user may cycle through alarm settings, e.g., the volume, intensity, pitch, and sequence of sound emitted from the speaker, or visual alarms, such as the color, intensity, or sequence of the LED lights. In another example, the interface 305 may allow the user to turn the electronic locking apparatus 100 to the ON function or OFF function.

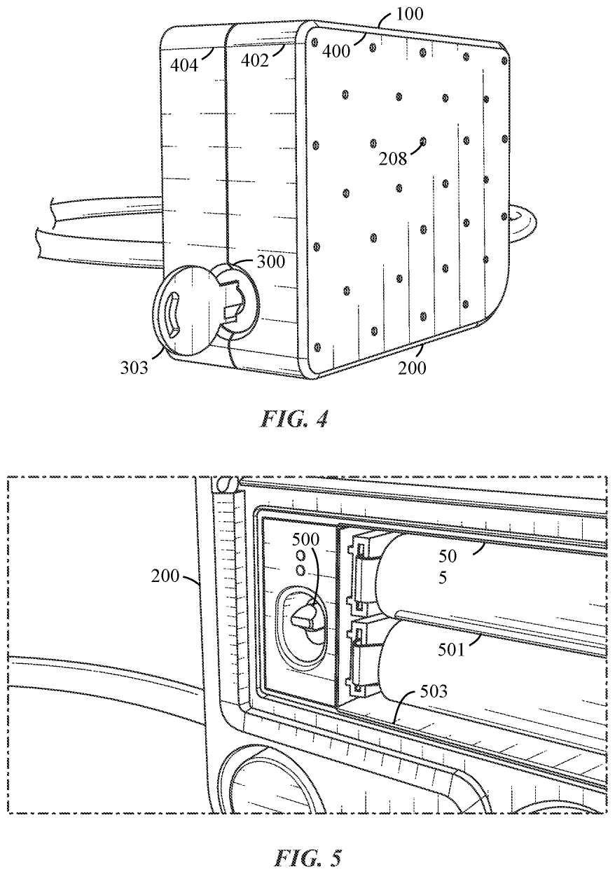

FIG. 4 illustrates a perspective view of the housing of the electronic locking apparatus 100 wherein the back surface 400 of the housing 200 at least partially includes the speaker 208 to emit sound when the alarm system is activated. The key 303 is engaged within the locking mechanism 300 to allow the user to connect and disconnect the locking base 306 from the receiver 204.

In some embodiments, and in further reference to FIG. 4, the housing 200 may include a first half 402 and a second half 404, which are separable via the locking mechanism 300 to permit the user to access internal components of the electronic locking apparatus 100, such as to replace the batteries.

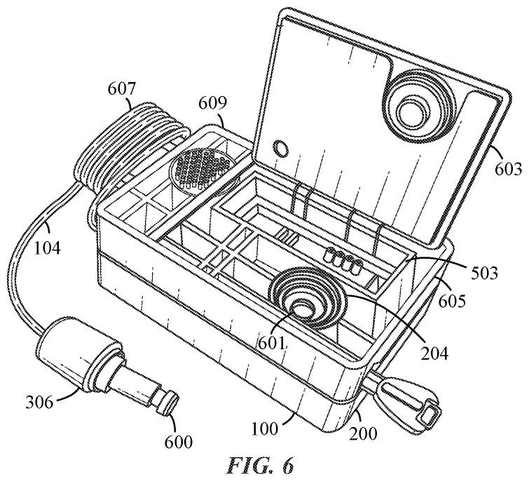

FIG. 5 illustrates a cutaway view of the power switch 500 and power source 501 provided within the interior 503 of the housing 200. Illustrated are batteries 505 providing power via electrical circuitry known in the arts. The power switch 500 may function to turn the device ON and OFF, or to activate and deactivate the alarm. The power switch 500 is disposed in the interior 503 such that the user must have the key 303 to unlock the door 603 (see FIG. 6) and access the power switch 500. In such, the apparatus 100 cannot be powered off accidentally or intentionally without the key 303.

FIG. 6 illustrates a perspective view of the electronic locking apparatus 100 having the locking base 306 disengaged from the receiver 204. The locking base 306 includes an elongated member 600 configured to extend at least partially through an aperture 601 in the center of the receiver 204. A door 603 is pivotally engaged with a top side 605 of the housing 200 to permit the user to access and interact with the interior 503 of the housing 200. A cable retainer 607 may be provided on the left side 609 of the housing 200 such that the user may wrap the cable 104 for organization when not in use.

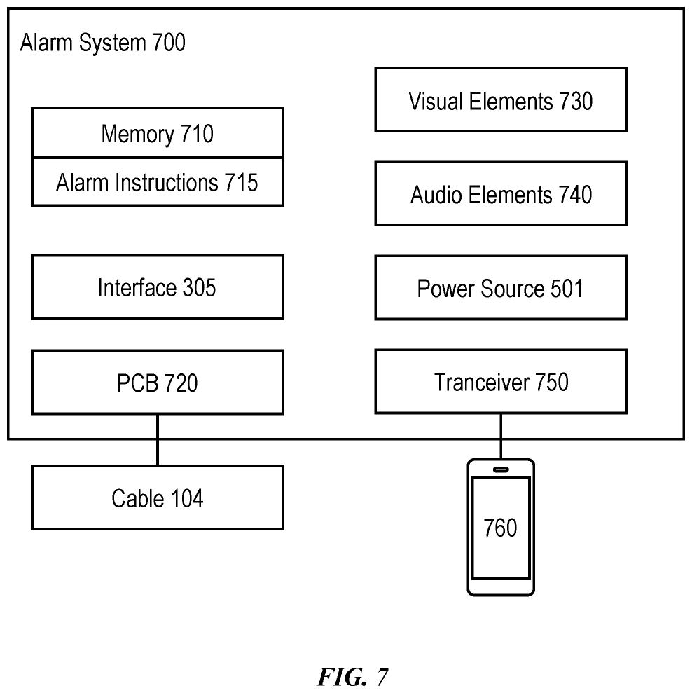

FIG. 7 illustrates a block diagram of the alarm system 700 including a memory 710 to store alarm instructions 715 and programmed having alarm protocols such as light intensities and sequences provided by the visual elements 730. The alarm instructions 715 may also include sound frequencies, intensity, and sequences provided by the audio elements 740. A printed circuit board (PCB) 720 is provided in communication with the cable 104 to determine if the cable 104 has been tampered with. The interface 305 allows the user to select alarm instruction 715 or other operational functions of the apparatus 100 as described herein. The power source 501 provides electrical power to the components of the alarm system 700. A transceiver 750 sends and receives signals to and from a remote device 760 in the event the cable 104 is severed or otherwise tampered with, and an alarm is activated. The remote device 760 may be a smartphone, tablet, computer, or other electronic device capable of sending and receiving information over a network. The remote device 760 may belong to the owner of the tools, a jobsite manager, local authorities, or the like.

In some embodiments, the alarm system 700 in the activated state is configured to produce an auditory alarm when the locking mechanism 300 is tampered with. An interface 305 may be provided on the locking base 306 to display the status of the locking indicator 307 and/or to provide a user interface for the user when locking and unlocking the apparatus 100. An indicator 307 may be provided on the locking base 306 to indicate the status of the locking mechanism 300 (such as by indicating a locked or unlocked status). The indicator 307 and interface 305 may function as visual alarm systems if the apparatus 100 is tampered with.

In some embodiments, the alarm system 700 is triggered when an alarm indicator 307 is severed, thus breaking a circuit which triggers an alarm response.

In some embodiments, the alarm system 700 further comprises a visual alarm. The visual alarm may be at least one strobe light, flashing LED(s), or similar visual element.

In some embodiments, locking base 306 may also include one or more status indicators 307. Status indicators 307 may be configured to provide a locked status of the tool lock and/or to alert a user when a communication was received by the system. Status indicators 307 may include light emitting diodes (LED's), speakers, and/or other audio and/or visual indicator of a particular status. As just one example, an LED may be illuminated in red to show that a particular tool lock is currently locked, while an LED (the same or different) may be illuminated in green to show that the tool lock is unlocked and disarmed. It will be appreciated that any indicator device, such as a speaker or interface display screen may be usable as a status indicator.

In some embodiments, the lock arm is an elongate U-shape. The lock arm may have a first end pivotably engaged within the locking base 306 and a second end selectively engageable within a receiving cavity of the locking mechanism 300. The lock arm may alternatively comprise a plurality of links so as to be flexibly wrapped around and through the tools.

In some embodiments, the apparatus 100 is operable using an application provided on a mobile device. The apparatus 100 may utilize Bluetooth or similar communication means to communicate with a mobile device and permit the user to control the various features of the apparatus 100 using the mobile device. For example, the user may download an application using their mobile device to permit the user to lock, unlock, or receive alerts from the apparatus 100 via the mobile device. In another example, the alarm signal may be transmitted to the mobile device if the apparatus is tampered with.

The apparatus 100 may also include one or more securement mechanisms. Securement mechanisms may be chains, rods, and/or other flexible and/or rigid components that may be used to secure a tool to another object such as a structure, toolbox, tool chest, lockbox, or other item known in the arts. The securement mechanism may be used in combination with the cable 104, or as a cable replacement to suit specific requirements, such as uniquely shaped, dimensioned or arranged toolboxes. Securement mechanisms often include metallic components that are resistant to cutting and other forces that may break the securement mechanism. At least one end of each securement mechanism may be removably secured within the locking base 306. For example, a lock latch or other mating feature may be provided at one end of the securement mechanism.

In some embodiments, the cable 104 is made of a cut-resistant material. In such, the cable 104 is tamperproof without the use of advanced cutting equipment. Electrical wiring may be disposed within the cut-resistant material such that if the cut-resistant material is breached, broken, or severed the alarm will be activated.

In some embodiments, the alarm system 700 includes a power source 501, a microprocessor in operable communication with the power source 501, and an interface 305 in operational communication with the microprocessor. The microprocessor places the alarm system 700 in the activated state when the locking mechanism 300 is engaged. The interface 305 is used to place the alarm system 700 in the deactivated state. The interface 305 may include a plurality of control buttons and an interface display screen. The alarm system 700 may further comprise a transceiver 750 chip in operational communication with the microprocessor to allow for remote notification of an alarm to a personal electronic device.

In some embodiments, the locking mechanism includes one of a keyed cylinder and combination cam, or an electronic cam including a fingerprint scanner or similar biometric scanner. The locking mechanism 300 may thus be locked and unlocked using a key 303, a combination dial, or a fingerprint, respectively.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. An electronic locking apparatus, comprising:
a housing including a locking mechanism to accept a key;
a cable attached to the left side of the housing, the cable in electrical communication with an alarm system, wherein the cable extends to a first end including a locking base, the locking base to releasably engage with a receiver positioned on the housing, wherein the locking mechanism selectively engages and releases the locking base from the receiver; and
the alarm system including at least one audio element and at least one visual element, the alarm system in electrical communication with the cable to determine if the cable is severed.

2. The electronic locking apparatus of claim 1, wherein the alarm system comprises a memory configured to store alarm instructions.

3. The electronic locking apparatus of claim 2, wherein the alarm instructions instruct the audio element to produce sound through at least one speaker positioned on the housing.

4. The electronic locking apparatus of claim 3, wherein the alarm instructions instruct the visual element to emit light via an LED positioned on the housing.

5. The electronic locking apparatus of claim 4, wherein the alarm system further comprises a transceiver to emit an alert signal to a remote device.

6. The electronic locking apparatus of claim 5, wherein the locking base is configured as an elongated member capable of at least partially extending through an aperture at a center of the receiver.

7. The electronic locking apparatus of claim 6, wherein the housing includes a pivotable door to permit access to an interior of the housing.

8. The tool alarm locking apparatus of claim 1, wherein the locking mechanism includes one of a keyed cylinder, a combination cam, and an electronic cam including a fingerprint scanner.

9. An electronic locking apparatus, comprising:
a housing including a locking mechanism to accept a key;
a cable attached to the left side of the housing, wherein the cable extends to a first end including a locking base, the locking base to releasably engage with a receiver positioned on the housing, wherein the locking mechanism selectively engages and releases the locking base from the receiver, wherein the cable is dimensioned to secure a toolbox to permit unauthorized entry thereto;
an alarm system including at least one audio element and at least one visual element, the alarm system in electrical communication with the cable to determine if the cable is tampered with; and
an interface in operable communication with the alarm system, the interface to permit the user to select alarm instructions of the alarm system.

10. The electronic locking apparatus of claim 9, wherein the alarm system comprises a memory configured to store alarm instructions.

11. The electronic locking apparatus of claim 10, wherein the alarm instructions instruct the audio element to produce sound through at least one speaker positioned on the housing.

12. The electronic locking apparatus of claim 11, wherein the alarm instructions instruct the visual element to emit light via an LED positioned on the housing.

13. The electronic locking apparatus of claim 12, wherein the alarm system further comprises a transceiver to emit an alert signal to a remote device.

14. The electronic locking apparatus of claim 13, wherein the remote device is in operable communication with the interface to permit remote operation of the electronic locking apparatus.

15. The electronic locking apparatus of claim 14, wherein the locking base is configured as an elongated member capable of at least partially extending through an aperture at a center of the receiver.

16. The electronic locking apparatus of claim 15, wherein the housing includes a pivotable door to permit access to an interior of the housing.

17. The tool alarm locking apparatus of claim 16, wherein the locking mechanism includes one of a keyed cylinder, a combination cam, and an electronic cam including a fingerprint scanner.

18. The tool alarm locking apparatus of claim 17, wherein the alarm system includes a power source, a microprocessor in operational communication with the power source, and an interface in operational communication with the microprocessor, the microprocessor placing the alarm system in the activated state when the locking mechanism is engaged, the interface being used to place the alarm system in the deactivated state.

19. The tool alarm locking apparatus of claim 18, wherein the housing includes a cable retainer positioned on the left side of the housing.

20. An electronic locking apparatus, comprising:
a housing including a locking mechanism to accept a key to selectively release and engage the locking mechanism;
a cable attached to the left side of the housing, the cable in electrical communication with a PCB of an alarm system, wherein the cable extends to a first end including a locking base, the locking base to releasably engage with a receiver positioned on the housing, wherein the locking mechanism selectively engages and releases the locking base from the receiver, wherein the cable is dimensioned to secure a toolbox to permit unauthorized entry thereto, and wherein the alarm system is configured to emit an alarm signal to a remote device via a transceiver if the cable is tampered with;
the alarm system including at least one audio element and at least one visual element, the alarm system in electrical communication with the cable to determine if the cable is tampered with; and
an interface in operable communication with the alarm system, the interface to permit the user to select alarm instructions of the alarm system, wherein the interface is in operable communication with the remote device via the transceiver to permit the remote operation of the electronic locking apparatus.
